(19) United States
(12) Patent Application Publication
(10) Pub. No.: US 2022/0384856 A1
(43) Pub. Date: Dec. 1, 2022

(54) MITIGATING THE ZINCATE EFFECT IN ENERGY DENSE MANGANESE DIOXIDE ELECTRODES

(71) Applicant: RESEARCH FOUNDATION OF THE CITY UNIVERSITY OF NEW YORK, New York, NY (US)

(72) Inventors: Gautam G. YADAV, New York, NY (US); Xia WEI, New York, NY (US); Michael NYCE, New York, NY (US); Sanjoy BANERJEE, New York, NY (US)

(21) Appl. No.: 17/772,577

(22) PCT Filed: Oct. 30, 2020
(86) PCT No.: PCT/US20/58312

§ 371 Date: Apr. 28, 2022

Related U.S. Application Data
(60) Provisional application No. 62/928,787, filed on Oct. 31, 2019.

(51) Int. Cl. H01M 10/26; H01M 4/36; H01M 4/505; H01M 4/485; H01M 4/62; H01M 4/04; H01M 4/583; H01M 4/66; H01M 4/74

(52) U.S. Cl. CPC H01M 10/26; H01M 4/366; H01M 4/364; H01M 4/505; H01M 4/485; H01M 4/623; H01M 4/0404; H01M 4/583; H01M 4/662; H01M 4/74; H01M 2004/028

(57) ABSTRACT

A battery includes a housing, an electrolyte disposed in the housing, an anode disposed in the housing, and an electrode disposed in the housing and comprising an electrode material comprising manganese dioxide, and a conductive carbon coated with a metallic layer. The use of the conductive carbon coated with the metallic layer can help to control the effects of other ions such as zincate on the manganese dioxide during discharge or cycling of the battery.

### CROSS-REFERENCE TO RELATED APPLICATIONS

This application claims the benefit of: U.S. Provisional Application No. 62/928,787 filed on Oct. 31, 2019 and entitled “Mitigating the Zincate Effect in Energy Dense Manganese Dioxide Electrodes”, which is incorporated herein by reference in its entirety for all purposes.

### STATEMENT REGARDING GOVERNMENTALLY SPONSORED RESEARCH OR DEVELOPMENT

This invention was made with Government support under grant number DEAR0000150 awarded by the U.S. Department of Energy. The government has certain rights in the invention.

### BACKGROUND

The alkaline battery is widely used because of its superior storage properties and high ionic conductivity compared to acidic or neutral electrolyte. However, these batteries are generally used only once and then discarded because of the inactivity of its raw materials. Also, the energy extracted from these batteries can become low through formation of various materials that limit the voltage and/or current over time. These characteristics curtail the use of this cheap, safe, nonflammable, and environmentally chemistry to small scale applications.

### SUMMARY

In an embodiment, a battery includes a housing, an electrolyte disposed in the housing, an anode disposed in the housing, and an electrode disposed in the housing and comprising an electrode material comprising manganese dioxide, and a conductive carbon coated with a metallic layer.

In an embodiment, a method of forming a battery comprises forming a metallic layer on a conductive carbon particle to form a conductive carbon with a metallic layer, combining the conductive carbon with the metallic layer with manganese dioxide to form an electrode mixture, forming an electrode from the electrode mixture, disposing the electrode in a housing, disposing an anode in the housing, and disposing an electrolyte in the housing to form the battery.

These and other features will be more clearly understood from the following detailed description taken in conjunction with the accompanying claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIGS. 1A-1D illustrate schematic representations of a battery according to some embodiments.

FIGS. 2A-2D illustrate data from Example 1 showing a comparison of the 2^{nd} discharge of experimental cells 1 and 2 in FIG. 1A, a comparison of 10^{th} discharge of cell 1 and 2 in FIG. 2B, a comparison of the 25^{th} discharge of cell 1 and 2 in FIG. 2C, and a comparison of cycles 2, 10, 25, and 36 for Cell 2 in FIG. 2D.

FIG. 3 illustrates the charge and discharge capacity of Cell 2 from Example 1.

FIG. 4 describes discharge curves of a 20Ah Zn/birnessite cell from Example 2.

### DESCRIPTION

In this disclosure, the terms “negative electrode” and “anode” are both used to mean “negative electrode.” Likewise, the terms “positive electrode” and “cathode” are both used to mean “positive electrode.” Reference to an “electrode” alone can refer to the anode, cathode, or both. Reference to the term “primary battery” (e.g., “primary battery,” “primary electrochemical cell,” or “primary cell”), refers to a cell or battery that after a single discharge is disposed of and replaced. Reference to the term “secondary battery” (e.g., “secondary battery,” “secondary electrochemical cell,” or “secondary cell”), refers to a cell or battery that can be recharged one or more times and reused.

Primary and secondary batteries are used as energy storage devices for a number of applications like electric vehicles, household appliances, grid-scale storage, etc. Some characteristics that are important in these batteries are high energy density, non-flammability, low toxicity, and low cost. Alkaline Zn-anode batteries satisfy all of the aforementioned requirements. The counter-electrodes or cathodes that help maintain these characteristics with Zn can include manganese dioxides or air electrodes. The inherent safety, low toxicity, and cost characteristics of the Zn/air and Zn/MnO₂ battery make it suitable to be used for many applications that involve human interactions. Also, theoretically these battery systems have energy densities higher than lithium-ion or lithium-based battery systems; however, in practice the energy densities are curtailed due to the low depth of discharge of the cathode components in these systems. The commonality of these two battery systems arise from the use of manganese dioxides as it is the cathode in the Zn/MnO₂ battery and it is the bi-functional catalyst used in the air cathode in the Zn/air battery, where the detrimental characteristic of the manganese dioxides is the reason for the curtailment in the energy density.

Manganese dioxide (MnO₂) in the Zn/MnO₂ battery can deliver its full theoretical capacity (˜617 mAh/g) through a two electron reaction, while in the Zn/air battery it works as the catalyst in the oxygen reduction and evolution reactions. The loss of energy density from these battery systems results from the loss in electrochemical activity of MnO₂. The inactivity results from accessing high utilization or depth of discharge (i.e., thepercentage of theoretical capacity), which results in forming hausmannite (Mn₃O₄), and its interaction with the dissolved Zn ions to form an electrochemically inactive phase of haeterolite (ZnMn₂O₄). Prior researchers have tried to mitigate these problems by limiting the capacity utilized (5-10% of 617 mAh/g) and using specialized membranes to curtail the effect of Zn. However, these approaches have led to significantly reduced energy density of the battery and added cost.

Recently, the accessibility of the 2^{nd} electron capacity was improved by using birnessite (δ-MnO₂, a layered polymorph of MnO₂) mixed with bismuth oxide (Bi₂O₃) and copper (Cu). The birnessite mixed with Bi₂O₃ and Cu (BBC) was able to deliver the complete 2^{nd} electron capacity for over 6000 cycles against a non-interacting counter electrode like sintered nickel. The BBC was also able to cycle against a Zn anode for over thousands of cycles and deliver the complete 2^{nd} electron capacity; however, Zn interaction with BBC created a resistive material that resulted in loss of potential. A loss in potential due to the resistive nature of the material results a loss in energy density. To solve this problem, a way of mitigating the Zn effect has been discovered by almost completely by coating a metallic layer, preferably nickel (Ni), over carbon which is the conductive component of the BBC electrode. The metallic coated carbon interacts with the BBC active material in an efficient way to minimize the effect of Zn, and thus, maintain potential while delivering the complete 2^{nd} electron capacity and maintain the high energy density.

The metallic coated carbon is also used in Zn-anode batteries, where electrolytic manganese dioxide (EMD) is used as the cathode or the catalyst. EMD is also capable of delivering 617 mAh/g; however, its capacity is curtailed between 0-310 mAh/g as the EMD undergoes phase transformation after accessing >310 mAh/g. The metallic coated carbon is also beneficial for the EMD material system to deliver its 0-100% of the 310 mAh/g capacity.

In this disclosure the coating of carbons like graphite, carbon nanotubes (multi and single walled), graphene, graphene oxide, carbon black, etc. with metals like nickel, copper, cobalt, tin, aluminum, nickel-phosphorous, and silver are provided that mitigate the effect of Zn on the discharge and charge behavior of various polymorphs of manganese dioxides like electrolytic manganese dioxide, birnessite, alpha—manganese dioxide, beta—manganese dioxide, lambda—manganese dioxide, etc. to maintain the capacity and potential that deliver high energy density for primary and secondary batteries.

Accordingly, a Zn-anode alkaline battery is described. The battery includes a zinc anode and a cathode with either manganese dioxide (all polymorphs) or air as the cathode material with manganese dioxide as the catalyst, a conductive carbon with a metal coating, and optionally, an additive. In some embodiments the additives can include copper or compound derivatives of copper and bismuth oxide or compound derivatives of bismuth or bismuth.

In some embodiments the manganese dioxide can be electrolytic manganese dioxide, alpha—manganese dioxide, beta—manganese dioxide, lambda—manganese dioxide, delta—manganese dioxide, epsilon—manganese dioxide, gamma—manganese dioxide and its many polymorphic derivatives.

In some embodiments the carbon can be graphite, carbon black, carbon nanotubes (multi and single walled), graphene, graphene oxide, expanded graphite, carbon fibers, etc. coated with metals like nickel, copper, tin, aluminum and silver. An advantage that may be realized in the practice of some disclosed embodiments of the battery is that a cathode containing manganese with its additives as the active material or the catalytic material is rendered unaffected by zinc and is left highly energy dense with a high utilization of the theoretical capacity while maintaining potential for primary and secondary battery applications.

This disclosure pertains to the development of a Zn-anode battery, where the manganese dioxide cathode or the air cathode containing manganese dioxide as the catalyst performance and energy density is maintained even in the presence of dissolved Zn ions (e.g., zincate) in the electrolyte. Applications for such a battery could be in grid-scale energy storage, traction batteries, aerospace applications, electric vehicles, power packs, telecommunications, uninterruptible power supply (UPS), medical applications, etc. to name a few.

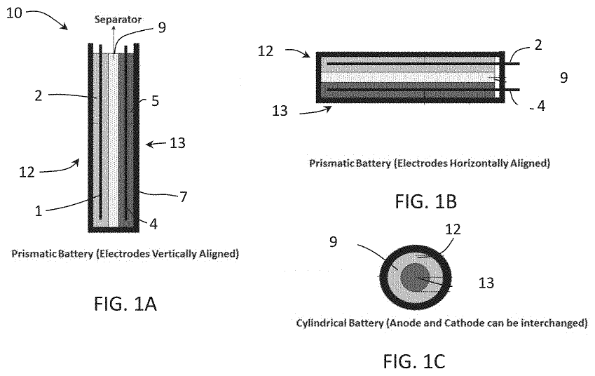

Some embodiments of the cell or battery design where this could be used is shown in FIG. 1. A prismatic and cylindrical battery design is shown, but it is not limited to these battery form factors. The battery comprises of a cathode, an anode, electrolyte and separator. The designs shown are just a guide and are not limited to the designs shown in the figure. The prismatic battery design was used to test the cathode.

Referring to FIG. 1, a cell or battery 10 can have a housing 7, a cathode 12, which can include a cathode current collector 1 and a cathode material 2, and an anode 13. In some embodiments, the anode 13 can comprise an anode current collector 4, and an anode material 5. It is noted that the scale of the components in FIG. 1 may not be exact as the features are illustrates to clearly show the electrolyte around the anode 13 and the cathode 12. FIG. 1 shows a prismatic battery arrangement having a single anode 13 and cathode 12. The prismatic configuration can have a number of form factors such as a vertical configuration as shown in FIG. 1A or a horizontal configuration as shown in FIG. 1B. In another embodiment, the battery can be a cylindrical battery having the electrodes arranged concentrically as shown in FIG. 1C or in a rolled configuration as shown in FIG. 1D in which the anode and cathode are layered and then rolled to form a jelly roll configuration. The cathode current collector 1 and cathode material 2 are collectively called either the cathode 12 or the positive electrode 12, as shown in FIG. 21A. Similarly, the anode material 5 with the optional anode current collector 4 can be collectively called either the anode 13 or the negative electrode 13. An electrolyte can be in contact with the cathode 12 and the anode 13 within the housing 7.

In some embodiments, the battery 10 can comprise one or more cathodes 12 and one or more anodes 13, which can be present in any configuration or form factor. When a plurality of anodes 13 and/or a plurality of cathodes 12 are present, the electrodes can be configured in a layered configuration such that the electrodes alternate (e.g., anode, cathode, anode, etc.). Any number of anodes 13 and/or cathodes 12 can be present to provide a desired capacity and/or output voltage. In the jellyroll configuration (e.g., as shown in FIG. 1D), the battery 10 may only have one cathode 12 and one anode 13 in a rolled configuration such that a cross section of the battery 10 includes a layered configuration of alternating electrodes, though a plurality of cathodes 12 and anodes 13 can be used in a layered configuration and rolled to form the rolled configuration with alternating layers.

In an embodiment, housing 7 comprises a molded box or container that is generally non-reactive with respect to the electrolyte solutions in the battery 10. In an embodiment, the housing 7 comprises a polymer (e.g., a polypropylene molded box, an acrylic polymer molded box, etc.), a coated metal, or the like.

The cathode 12 can comprise a mixture of components including an electrochemically active material. Additional components such as a binder, a conductive material, and/or one or more additional components can also be optionally included that can serve to improve the lifespan, rechargeability, and electrochemical properties of the cathode 12. The cathode 12 can comprise a cathode material 2 (e.g., an electroactive material, additives, etc.). The cathode used can be manganese dioxide for Zn/MnO₂ battery or air with manganese dioxide as the catalyst for the bifunctional electrocatalytic reactions in a Zn/air battery.

In some embodiments, the cathode material 2 can be based on one or many polymorphs of MnO₂, including electrolytic (EMD), α-MnO₂, β-MnO₂, γ-MnO₂, δ-MnO₂, ε-MnO₂, λ-MnO₂, and/or chemically modified manganese dioxide. Other forms of MnO₂ can also be present such as hydrated MnO₂, pyrolusite, birnessite, ramsdellite, hollandite, romanechite, todorkite, lithiophorite, chalcophanite, sodium or potassium rich birnessite, cryptomelane, buserite, manganese oxyhydroxide (MnOOH), α-MnOOH, γ-MnOOH, β-MnOOH, manganese hydroxide [Mn(OH)₂], partially or fully protonated manganese dioxide, Mn₃O₄, Mn₂O₃, bixbyite, MnO, lithiated manganese dioxide (LiMn₂O₄, Li₂MnO₃), CuMn₂O₄, aluminum manganese oxide, zinc manganese dioxide, bismuth manganese oxide, copper intercalated birnessite, copper intercalated bismuth birnessite, tin doped manganese oxide, magnesium manganese oxide, or any combination thereof. In general the cycled form of manganese dioxide in the cathode can have a layered configuration, which in some embodiment can comprise δ-MnO₂ that is interchangeably referred to as birnessite. If non-birnessite polymorphic forms of manganese dioxide are used, these can be converted to birnessite in-situ by one or more conditioning cycles as described in more details below. For example, a full or partial discharge to the end of the MnO₂ second electron stage (e.g., between about 20% to about 100% of the 2^{nd} electron capacity of the cathode) may be performed and subsequently recharging back to its Mn⁴⁺ state, resulting in birnessite-phase manganese dioxide.

In some embodiments, the cathode composition is 1-90 wt. % manganese dioxide, 0-30 wt. % bismuth or bismuth-based compounds, 0-50 wt. % copper or copper-based compounds, 1-90 wt. % conductive carbon coated with metallic layer and 0-10 wt. % binder.

In some embodiments, a binder can be used with the cathode material 2. The binder can be present in a concentration of between about 0-10 wt. %. In some embodiments, the binder comprises water-soluble cellulose-based hydrogels, which can be used as thickeners and strong binders, and have been cross-linked with good mechanical strength and with conductive polymers. The binder may also be a cellulose film sold as cellophane. The binders can be made by physically cross-linking the water-soluble cellulose-based hydrogels with a polymer through repeated cooling and thawing cycles. In some embodiments, the binder can comprise a 0-10 wt. % methyl cellulose (MC) and/or carboxymethyl cellulose (CMC) solution cross-linked with 0-10 wt. % polyvinyl alcohol (PVA) on an equal volume basis. The binder, compared to the traditionally-used PTFE, shows superior performance. PTFE is a very resistive material, but its use in the industry has been widespread due to its good rollable properties. This, however, does not rule out using PTFE as a binder. Mixtures of PTFE with the aqueous binder and some conductive carbon can be used to create rollable binders. Using the aqueous-based binder can help in achieving a significant fraction of the two electron capacity with minimal capacity loss over many cycles. In some embodiments, the binder can be water-based, have superior water retention capabilities, adhesion properties, and help to maintain the conductivity relative to an identical cathode using a PTFE binder instead. Examples of suitable water based hydrogels can include, but are not limited to, methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose, hydroxyethyl cellulose (HEC), and combinations thereof. Examples of crosslinking polymers include polyvinyl alcohol, polyvinylacetate, polyaniline, polyvinylpyrrolidone, polyvinylidene fluoride, polypyrrole, and combinations thereof. In some embodiments, a 0-10 wt. % solution of water-cased cellulose hydrogen can be cross linked with a 0-10 wt. % solution of crosslinking polymers by, for example, repeated freeze/thaw cycles, radiation treatment, and/or chemical agents (e.g. epichlorohydrin). The aqueous binder may be mixed with 0-5% wt. % PTFE to improve manufacturability.

The cathode material 2 can also comprise additional elements. The additional elements can be included in the cathode material including a bismuth compound and/or copper/copper compounds, which together allow improved galvanostatic battery cycling of the cathode. When present as birnessite, the copper and/or bismuth can be incorporated into the layered nanostructure of the birnessite. The resulting birnessite cathode material can exhibit improved cycling and long term performance with the copper and bismuth incorporated into the crystal and nanostructure of the birnessite.

The bismuth or bismuth-based compounds are used to access greater capacity (20-100% of 617 mAh/g) from the manganese dioxide 2^{nd} electron capacity. They are used in batteries where manganese dioxide is usually the layered-phase birnessite. It is also used in batteries where the manganese dioxide can be any polymorph and discharging it completely to 617 mAh/g and charging it back results in the formation of birnessite. In batteries, where accessing 0-100% of 310 mAh/g of the manganese dioxide capacity (e.g., accessing the 1^{st} electron capacity with a material such as EMD), bismuth or bismuth-based compounds may or may not be used.

The bismuth compound can be incorporated into the cathode 12 as an inorganic or organic salt of bismuth (oxidation states 5, 4, 3, 2, or 1), as a bismuth oxide, or as bismuth metal (i.e. elemental bismuth). Examples of bismuth compounds include bismuth oxide, bismuth chloride, bismuth bromide, bismuth fluoride, bismuth iodide, bismuth sulfate, bismuth nitrate, bismuth trichloride, bismuth citrate, bismuth telluride, bismuth selenide, bismuth subsalicylate, bismuth neodecanoate, bismuth carbonate, bismuth subgallate, bismuth strontium calcium copper oxide, bismuth acetate, bismuth trifluoromethanesulfonate, bismuth nitrate oxide, bismuth gallate hydrate, bismuth phosphate, bismuth cobalt zinc oxide, bismuth sulphite agar, bismuth oxychloride, bismuth aluminate hydrate, bismuth tungsten oxide, bismuth lead strontium calcium copper oxide, bismuth antimonide, bismuth antimony telluride, bismuth oxide yittia stabilized, bismuth-lead alloy, ammonium bismuth citrate, 2-napthol bismuth salt, duchloritri(o-tolyl)bismuth, dichlordiphenyl(p-tolyl)bismuth, or triphenylbismuth.

The copper or copper-based compounds are used to access greater capacity (20-100% of 617 mAh/g) from the manganese dioxide 2^{nd} electron capacity. They are used in batteries where manganese dioxide is usually the layered-phase birnessite. It is also used in batteries where the manganese dioxide can be any polymorph and discharging it completely to 617 mAh/g and charging it back results in the formation of birnessite. It is desirable to be used in batteries accessing 20-100% of 617 mAh/g for thousands of cycles as Cu helps in the rechargeability and reducing the charge transfer resistance. In batteries, where accessing 0-100% of 310 mAh/g of the manganese dioxide capacity (e.g., accessing the 1^{st} electron capacity with a material such as EMD), copper or copper-based compounds may or may not be used. The effect of copper is to alter the oxidation and reduction voltages of bismuth. This results in a cathode with full reversibility during galvanostatic cycling, as compared to a bismuth-modified MnO₂ which cannot withstand galvanostatic cycling as well.

The copper compound can be incorporated into the cathode 12 as an organic or inorganic salt of copper (oxidation states 1, 2, 3, or 4), as a copper oxide, or as copper metal (i.e., elemental copper). The copper compound can be present in a concentration between about 1-70 wt. % of the weight of the cathode material 2. In some embodiments, the copper compound is present in a concentration between about 5-50 wt. % of the weight of the cathode material 2. In other embodiments, the copper compound is present in a concentration between about 10-50 wt. % of the weight of the cathode material 2. In yet other embodiments, the copper compound is present in a concentration between about 5-20 wt. % of the weight of the cathode material 2. Examples of copper compounds include copper and copper salts such as copper aluminum oxide, copper (I) oxide, copper (II) oxide and/or copper salts in a +1, +2, +3, or +4 oxidation state including, but not limited to, copper nitrate, copper sulfate, copper chloride, etc.

The addition of conductive carbon allows higher loadings of MnO₂ to be used that increase gravimetric and volumetric energy density. The conductive additive can be present in a concentration between about 1-30 wt. %. Example of conductive carbon include single walled carbon nanotubes, multiwalled carbon nanotubes, graphene, carbon blacks of various surface areas, and others that have specifically very high surface area and conductivity. Higher loadings of the MnO₂ in the mixed material electrode are, in some embodiments, desirable to increase the energy density. Other examples of conductive carbon include TIMREX Primary Synthetic Graphite (all types), TIMREX Natural Flake Graphite (all types), TIMREX MB, MK, MX, KC, B, LB Grades(examples, KS15, KS44, KC44, MB15, MB25, MK15, MK25, MK44, MX15, MX25, BNB90, LB family) TIMREX Dispersions; ENASCO 150G, 210G, 250G, 260G, 350G, 150P, 250P; SUPER P , SUPER P Li, carbon black (examples include Ketjenblack EC-300J, Ketjenblack EC-600JD, Ketjenblack EC-600JD powder), acetylene black, carbon nanotubes (single or multi-walled), graphene, graphyne, graphene oxide, Zenyatta graphite and combinations thereof.

In some embodiments, the conductive additive can have a particle size range from about 1 to about 50 microns, or between about 2 and about 30 microns, or between about 5 and about 15 microns. The total conductive additive mass percentage in the cathode material 2 can range from about 5% to about 99% or between about 10% to about 80%. In some embodiments, the electroactive component in the cathode material 2 can be between 1 and 99 wt. % of the weight of the cathode material 2, and the conductive additive can be between 1 and 99 wt. %.

As disclosed herein, a metallic layer can be deposited on the carbon to maintain the cathode's enhanced properties even in the presence of dissolved zinc in the electrolyte. Dissolved zinc or zincate is known to interact with the manganese dioxide to create a resistive material (haetaerolite, ZnMn₂O₄) that losses potential and capacity. The bismuth and copper or their compound-based additives help maintain the capacity loss; however, potential loss is still an issue. The metallic layer on carbon helps maintain the potential in the cells that eventually lead to an energy dense cathode and battery. The metallic layer can comprise any suitable metal including, but not limited to, nickel, copper, tin, cobalt, nickel-phosphorous, aluminum and silver. The metallic layer can also comprise the deposition of a metal salt of any of the metals listed such as a metal phosphate. The carbon coated metallic layer also helps in increasing the energy efficiency of the cell or battery 10.

The metallic deposition/coating of the carbon can be done by any suitable method. In some embodiments, the metallic layer can be formed on the carbon using chemical vapor deposition, physical vapor deposition like thermal evaporation and sputtering. The metallic deposition/coating can also be performed through electrochemical methods like electroless plating or through a power source.

In an embodiment, the metallic layer can be coated onto the carbon (e.g., any of the carbon additives described herein such as carbon nanotubes, etc.) using an electroless plating solution process. In this process, a reducing agent is used with a solution with the desired metal or metals to plate the carbon. Reducing agents such as sodium hypophosphite can be used to reduce the metal/metals onto the surface of the carbon, thereby forming the metallic layer on the carbon. In some embodiments, the electroless plating solution process can result in the deposition of a metallic salt onto the surface of the carbon. The carbon can then be washed to remove the plating solution while the metallic layer can remain on the carbon. The coated carbon can then be combined with the other ingredients for the cathode and formed into the cathode 12.

In some embodiments, the cathode material 2 can also comprise a conductive component. The addition of a conductive component such as metal additives to the cathode material 2 may be accomplished by addition of one or more metal powders such as nickel powder to the cathode material 2. The conductive metal component can be present in a concentration of between about 0-30 wt. % in the cathode material 2. The conductive metal component may be, for example, nickel, copper, silver, gold, tin, cobalt, antimony, brass, bronze, aluminum, calcium, iron, or platinum. In one embodiment, the conductive metal component is a powder. In some embodiments, the conductive component can be added as an oxide and/or salt. For example, the conductive component can be cobalt oxide, cobalt hydroxide, lead oxide, lead hydroxide, or a combination thereof. In some embodiments, a second conductive metal component is added to act as a supportive conductive backbone for the first and second electron reactions to take place. The second electron reaction has a dissolution-precipitation reaction where Mn³⁺ ions become soluble in the electrolyte and precipitate out on the materials such as graphite resulting in an electrochemical reaction and the formation of manganese hydroxide [Mn(OH)₂] which is non-conductive. This ultimately results in a capacity fade in subsequent cycles. Suitable conductive components that can help to reduce the solubility of the manganese ions include transition metals like Ni, Co, Fe, Ti and metals like Ag, Au, Al, Ca. Oxides and salts of such metals are also suitable. Transition metals like Co can also help in reducing the solubility of Mn³⁺ ions. Such conductive metal components may be incorporated into the electrode by chemical means or by physical means (e.g. ball milling, mortar/pestle, spex mixture). An example of such an electrode comprises 5-95% birnessite, 5-95% conductive carbon, 0-50% conductive component (e.g., a conductive metal), and 1-10% binder.

The cathode material 2 can be formed on a cathode current collector 1, which can be formed from a conductive material that serves as an electrical connection between the cathode material and an external electrical connection or connections. In some embodiments, the cathode current collector 1 can be made from, for example, carbon, lead, nickel, steel (e.g., stainless steel, etc.), nickel-coated steel, nickel plated copper, tin-coated steel, copper plated nickel, silver coated copper, copper, magnesium, aluminum, tin, iron, platinum, silver, gold, titanium, bismuth, titanium, half nickel and half copper, or any combination thereof In some embodiments, the current collector 1 can comprise a carbon felt or conductive polymer mesh. The cathode current collector may be formed into a mesh (e.g., an expanded mesh, woven mesh, etc.), perforated metal, foam, foil, felt, fibrous architecture, porous block architecture, perforated foil, wire screen, a wrapped assembly, or any combination thereof. In some embodiments, the current collector can be formed into or form a part of a pocket assembly, where the pocket can hold the cathode material 2 within the current collector 1. A tab (e.g., a portion of the cathode current collector 1 extending outside of the cathode material 2 as shown at the top of the cathode 12 in FIG. 1) can be coupled to the current collector to provide an electrical connection between an external source and the current collector.

In some embodiments, the anode can comprise zinc, iron, aluminum, lithium, and/or magnesium. When the anode comprises zinc, the anode 13 can comprise zinc in the form of Zn metal (100 wt. %), zinc oxide, and/or Zn powder of various morphologies (sphere, fiber, wire, tube, sheet, etc.) and sizes. An anode containing Zn powder as the active material can comprise 1-99 wt. % Zn powder, 0-99 wt. % zinc oxide (ZnO) and the remaining wt. % as binder. In some embodiment, the Zn may be present in the anode material 5 in an amount of from about 50 wt. % to about 90 wt. %, alternatively from about 60 wt. % to about 80 wt. %, or alternatively from about 65 wt. % to about 75 wt. %, based on the total weight of the anode material. In some embodiments conductive additives, gas inhibitor(s), and/or complexing additives like lithium, copper (Cu), indium, iron, cadmium, bismuth, aluminum, calcium, oxides thereof, hydroxides thereof, or any combination thereof can be added in 1-20 wt. %.

In some embodiments, the anode material 5 can comprise zinc oxide (ZnO), which may be present in an amount of from about 5 wt. % to about 20 wt. %, alternatively from about 5 wt. % to about 15 wt. %, or alternatively from about 5 wt. % to about 10 wt. %, based on the total weight of anode material. As will be appreciated by one of skill in the art, and with the help of this disclosure, the purpose of the ZnO in the anode mixture is to provide a source of Zn during the recharging steps, and the zinc present can be converted between zinc and zinc oxide during charging and discharging phases.

In an embodiment, an electrically conductive material may be optionally present in the anode material in an amount of from about 5 wt. % to about 20 wt. %, alternatively from about 5 wt. % to about 15 wt. %, or alternatively from about 5 wt. % to about 10 wt. %, based on the total weight of the anode material. As will be appreciated by one of skill in the art, and with the help of this disclosure, the electrically conductive material can be used in the anode mixture as a conducting agent, e.g., to enhance the overall electric conductivity of the anode mixture. Non-limiting examples of electrically conductive material suitable for use can include any of the conductive carbons described herein such as carbon, graphite, graphite powder, graphite powder flakes, graphite powder spheroids, carbon black, activated carbon, conductive carbon, amorphous carbon, glassy carbon, and the like, or combinations thereof. The conductive carbons can be used alone or with the metallic coating or layer as described herein for use with the cathode. The conductive material can also comprise any of the conductive carbon materials described with respect to the cathode material including, but not limited to, acetylene black, single walled carbon nanotubes, multi-walled carbon nanotubes, graphene, graphyne, or any combinations thereof (e.g., with or without the metallic coating(s)).

The anode material 5 may also comprise a binder. Generally, a binder functions to hold the electroactive material particles together and in contact with the current collector. The binder can be present in a concentration of 0-10 wt %. The binders may comprise water-soluble cellulose-based hydrogels like methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose and hydroxyethyl cellulose (HEC), which were used as thickeners and strong binders, and have been cross-linked with good mechanical strength and with conductive polymers like polyvinyl alcohol, polyvinylacetate, polyaniline, polyvinylpyrrolidone, polyvinylidene fluoride and polypyrrole. The binder may also be a cellulose film sold as cellophane. The binder may also be PTFE, which is a very resistive material, but its use in the industry has been widespread due to its good rollable properties. In some embodiments, the binder may be present in anode material in an amount of from about 2 wt. % to about 10 wt. %, alternatively from about 2 wt. % to about 7 wt. %, or alternatively from about 4 wt. % to about 6 wt. %, based on the total weight of the anode material.

In some embodiments, the anode material 5 can be used by itself without a separate anode current collector 4, though a tab or other electrical connection can still be provided to the anode material 5. In this embodiment, the anode material may have the form or architecture of a foil, a mesh, a perforated layer, a foam, a felt, or a powder. For example, the anode can comprise a metal foil electrode, a mesh electrode, or a perforated metal foil electrode. In some embodiments, the anode 13 can comprise an optional anode current collector 4. The anode current collector 4 can be used with an anode 13, including any of those described with respect to the cathode 12.

The cathode and anode materials can be adhered to their respective current collector(s) by pressing at, for example, a pressure between 1,000 psi and 20,000 psi (between 6.9×10⁶ and 1.4×10⁸ Pascals). The cathode and anode materials may be adhered to the current collector as a paste. A tab of each current collector can extend outside of the device. In some embodiments, the tab can covers less than 0.2% of the electrode area. The resulting cathode 12 and/or anode 13 can have a thickness of between about 0.1 mm to about 5 mm.

In some embodiments, a separator can be disposed between the anode 13 and the cathode 12 when the electrodes are constructed into the cell or battery 10. While shown as being disposed between the anode 13 and the cathode 12 in FIG. 1A, the separator 9 can be used to wrap one or more of the anode 13 and/or the cathode 12, or alternatively one or more anodes 13 and/or cathodes 12 when multiple anodes 13 and cathodes 12 are present.

The separator 9 may comprise one or more layers. For example, when the separator is used, between 1 to 5 layers of the separator can be applied between adjacent electrodes. The separator can be formed from a suitable material such as nylon, polyester, polyethylene, polypropylene, poly(tetrafluoroethylene) (PTFE), poly(vinyl chloride) (PVC), polyvinyl alcohol, cellulose, or any combination thereof. Suitable layers and separator forms can include, but are not limited to, a polymeric separator layer such as a sintered polymer film membrane, polyolefin membrane, a polyolefin nonwoven membrane, a cellulose membrane, a cellophane, a battery-grade cellophane, a hydrophilically modified polyolefin membrane, and the like, or combinations thereof. As used herein, the phrase “hydrophilically modified” refers to a material whose contact angle with water is less than 45°. In another embodiment, the contact angle with water is less than 30°. In yet another embodiment, the contact angle with water is less than 20°. The polyolefin may be modified by, for example, the addition of TRITON X100™ or oxygen plasma treatment. In some embodiments, the separator 9 can comprise a CELGARD® brand microporous separator. In an embodiment, the separator 9 can comprise a FS 2192 SG membrane, which is a polyolefin nonwoven membrane commercially available from Freudenberg, Germany. In some embodiments, the separator can comprise a lithium super ionic conductor (LISICON®), sodium super ionic conductions (NASICON), NAFION®, a bipolar membrane, water electrolysis membrane, a composite of polyvinyl alcohol and graphene oxide, polyvinyl alcohol, crosslinked polyvinyl alcohol, or a combination thereof.

An electrolyte (e.g. an alkaline hydroxide, such as NaOH, KOH, LiOH, or mixtures thereof) can be contained within the free spaces of the electrodes 12, 13, the separator 9, and the housing 7. The electrolyte may have a concentration of between 5% and 50% w/w. The electrolyte can be in the form of a liquid and/or gel. For example, the battery 10 can comprise an electrolyte that can be gelled to form a semi-solid polymerized electrolyte. In some embodiments, the electrolyte can be an alkaline electrolyte. The alkaline electrolyte can be a hydroxide such as potassium hydroxide, sodium hydroxide, lithium hydroxide, ammonium hydroxide, cesium hydroxide, or any combination thereof. The resulting electrolyte can have a pH greater than 7, for example between 7 and 15.1. In some embodiments, the pH of the electrolyte can be greater than or equal to 10 and less than or equal to about 15.13.

In addition to a hydroxide, the electrolyte can comprise additional components. In some embodiments, the alkaline electrolyte can have zinc oxide, potassium carbonate, potassium iodide, and/or potassium fluoride as additives. When zinc compounds are present in the electrolyte, the electrolyte can comprise zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, sodium hydroxide, potassium hydroxide, lithium hydroxide, potassium chloride, sodium chloride, potassium fluoride, lithium nitrate, lithium chloride, lithium bromide, lithium bicarbonate, lithium acetate, lithium sulfate, lithium permanganate, lithium nitrate, lithium nitrite, lithium perchlorate, lithium oxalate, lithium fluoride, lithium carbonate, lithium bromate, acrylic acid, N,N′-Methylenebisacrylamide, potassium persulfate, ammonium persulfate, sodium persulfate, or a combination thereof.

In some embodiments, the electrolyte can be an aqueous solution having an acidic or neutral pH. When the electrolyte is acid, the electrolyte can comprise an acid such as a mineral acid (e.g., hydrochloric acid, nitric acid, sulfuric acid, etc.). In some embodiments, the electrolyte solution can comprise a solution comprising potassium permanganate, sodium permanganate, lithium permanganate, calcium permanganate, manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, magnesium sulfate, zinc sulfate, zinc triflate, zinc acetate, zinc nitrate, bismuth chloride, bismuth nitrate, nitric acid, sulfuric acid, hydrochloric acid, sodium sulfate, potassium sulfate, sodium hydroxide, potassium hydroxide, titanium sulfate, titanium chloride, lithium nitrate, lithium chloride, lithium bromide, lithium bicarbonate, lithium acetate, lithium sulfate, lithium nitrate, lithium nitrite, lithium hydroxide, lithium perchlorate, lithium oxalate, lithium fluoride, lithium carbonate, lithium sulfate, lithium bromate, or any combination thereof. In some embodiments, the electrolyte can be an acidic or neutral solution, and the pH of the electrolyte can be between 0 and 7.

In some embodiments, the electrolyte can comprise a gassing inhibitor that can coat on metallic anodes surface and reduce or prevent gas formation. In an embodiment, gassing inhibitors can be used that are mixed in with the electrolyte. Suitable gassing inhibitors can include, but are not limited to, indium hydroxide, indium, indium oxide, bismuth oxide, bismuth, carboxymethyl cellulose, polyethylene glycol, zinc oxide, cetyltrimethylammonium bromide, polytetrafluoroethylene, and combinations thereof.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

In this example, two prismatic Zn/MnO₂ cells were constructed (e.g., having a design shown in FIG. 1A). The cells were set to access 100% of the 617 mAh/g 2^{nd} electron capacity from the MnO₂. Cell 1 was the baseline cell, where the cathode consisted of 40.77 wt. % electrolytic manganese dioxide (EMD or MnO₂), 8.15 wt. % bismuth oxide (Bi₂O₃), 32.6% carbon nanotubes (CNT) and the remaining elemental copper. Cell 2 cathode consisted of 40.77 wt. % electrolytic manganese dioxide (EMD or MnO₂), 8.15 wt. % bismuth oxide (Bi₂O₃), 32.6% carbon nanotubes (CNT) plated with Ni and the remaining elemental copper. The CNT's were plated with Ni by an electroless Ni plating solution. The process relies on using a reducing agent like sodium hypophosphite which reduces the nickel on the CNTs. The CNT's could have a layer of nickel-phosphorous remaining on it. The CNT-Ni samples are then washed in DI water and mixed with the remaining cathode components. The EMD gets converted into the birnessite phase after the 1^{st} complete discharge and complete recharge to its charged state. The birnessite phase of the MnO₂ delivers the capacity for the remaining cycle life of the battery, which could be for primary or secondary purposes. The anodes consisted of 85% zinc, 10% zinc oxide and 5% TEFLON. The total utilization of the Zn electrode was around 13%. The electrodes were pasted and pressed onto a Ni foil current collector. Three layers of cellophane were wrapped around the MnO₂ cathode, and Celgard 5550 and Freudenberg membrane was use to wrap the zinc electrodes. 25% KOH was used as the electrolyte. A constant current on charge and discharge and constant potential on charge protocol was used.

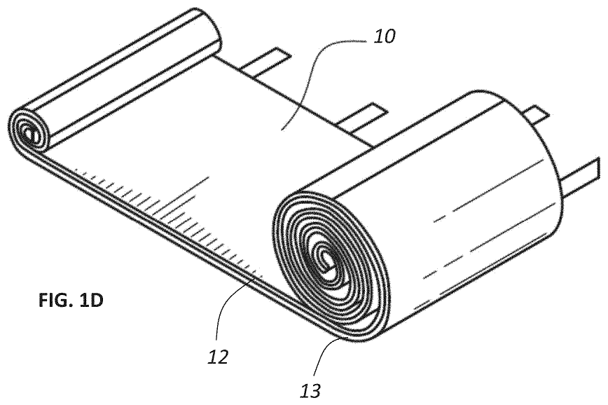

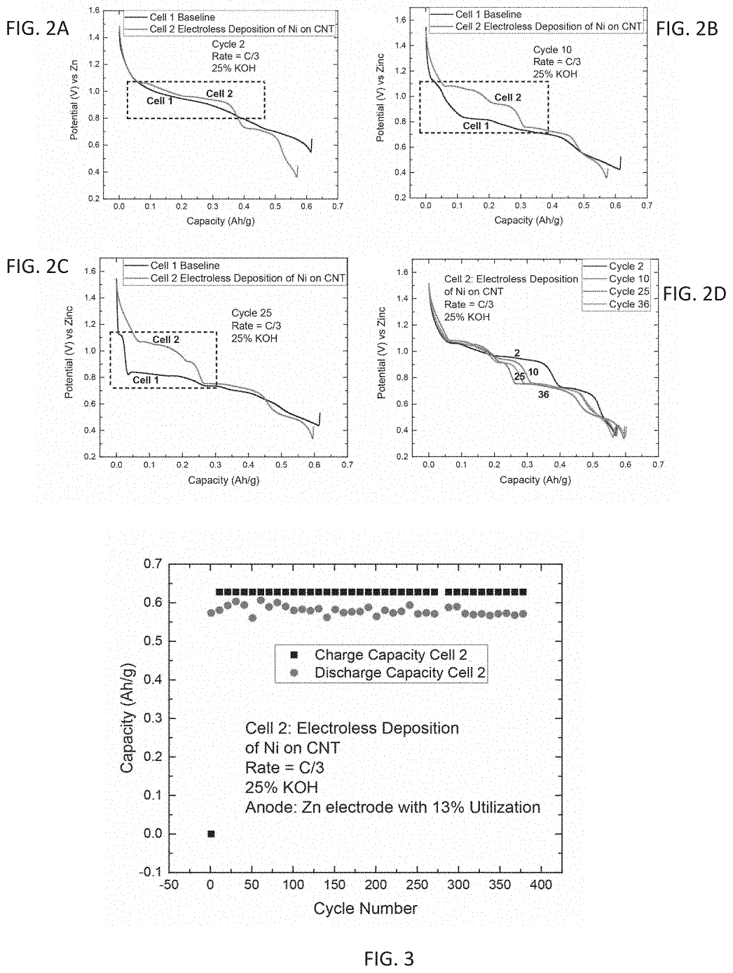

FIGS. 2 and 3 show the cycling performances for Cell 1 and 2. The overall capacities that were obtained in both the cells were approximately similar as seen in FIG. 2. Cell 2 clearly showed better potential maintenance compare to Cell 1 as shown in FIGS. 2A, 2B and 2C. Zn reacts with the birnessite in Cell 1 immediately to reduce potential by creating a resistive phase. However, the electroless deposition of nickel on the CNTs in Cell 2 seems to mitigate the effect of Zn on the cathode performance. The maintenance of the capacity and potential curves for every cycle ensures a stable and high energy density deliverance. FIG. 2D shows the maintenance of the potential and capacity curves of Cell 2 at different cycle life. FIG. 3 shows the cycle life performance of a Zn/MnO₂ cell at 13% Zn utilization and 100% MnO₂ 2^{nd} electron utilization. The maintenance of the capacity and potential for over 370 cycles ensures a stable and highly energy dense cell. The cathode components of Cell 2 can also be used as a catalyst for Zn/air cells.

### Example 2

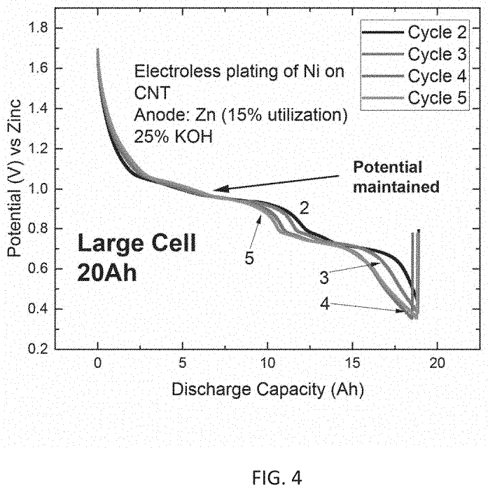

FIG. 4 shows the discharge curves (cycles 2-5) of a large 20 Ah cell. The cathode composition is 40.77 wt. % electrolytic manganese dioxide (EMD or MnO₂), 8.15 wt. % bismuth oxide (Bi₂O₃), 32.6% carbon nanotubes (CNT) plated with Ni and the remaining elemental copper. The CNTs were coated with nickel through electroless nickel coating/deposition. The coating layer could also be nickel-phosphorous as sodium hypophosphate helps in reducing nickel ions on the surface of the CNTs. 25 wt. % KOH was used as the electrolyte and Zn was used as the anode with ˜12-14% utilization. The potential of the curves are maintained for the large 20 Ah cell. The CNT coated Ni helps in maintaining and stabilizing the flat potential as shown in the figure even in the presence of zincate ions. This has not been achieved in literature in Zn/birnessite cells. A high energy efficiency of 65-68% was achieved for the cell.

Having described various batteries, systems, and methods, specific aspects can include, but are not limited to:

In a first aspect, a battery comprises: a housing; an electrolyte disposed in the housing; an anode disposed in the housing; an electrode disposed in the housing and comprising an electrode material comprising: manganese dioxide; and a conductive carbon coated with a metallic layer.

A second aspect can include the battery of the first aspect, wherein the electrode material further comprises: bismuth or a bismuth-based compound; and copper or a copper-based compound.

A third aspect can include the battery of the first or second aspect, wherein the anode comprises at least 50 wt. % zinc, and wherein the zinc comprises metallic zinc or zinc oxide.

A fourth aspect can include the battery of the first or second aspect, wherein the anode comprises zinc, iron, aluminum, lithium or magnesium.

A fifth aspect can include the battery of any one of the first to fourth aspects, wherein the manganese dioxide comprises alpha-manganese dioxide, beta-manganese dioxide, gamma-manganese dioxide, lambda-manganese dioxide, epsilon-manganese dioxide, delta-manganese dioxide (or birnessite), chemically modified manganese dioxide, electrolytic manganese dioxide (EMD), or a combination thereof.

A sixth aspect can include the battery of any one of the first to fifth aspects, wherein the electrode is a cathode disposed in the housing, and wherein the cathode comprises bismuth or a bismuth-based compounds.

A seventh aspect can include the battery of the sixth aspect, wherein the cathode comprises bismuth oxide, bismuth chloride, bismuth bromide, bismuth fluoride, bismuth iodide, bismuth sulfate, bismuth nitrate, bismuth trichloride, bismuth citrate, bismuth telluride, bismuth selenide, bismuth subsalicylate, bismuth neodecanoate, bismuth carbonate, bismuth subgallate, bismuth strontium calcium copper oxide, bismuth acetate, bismuth trifluoromethanesulfonate, bismuth nitrate oxide, bismuth gallate hydrate, bismuth phosphate, bismuth cobalt zinc oxide, bismuth sulphite agar, bismuth oxychloride, bismuth aluminate hydrate, bismuth tungsten oxide, bismuth lead strontium calcium copper oxide, bismuth antimonide, bismuth antimony telluride, bismuth oxide yittia stabilized, bismuth-lead alloy, ammonium bismuth citrate, 2-napthol bismuth salt, duchloritri(o-tolyl)bismuth, dichlordiphenyl(p-tolyl)bismuth, or triphenylbismuth

An eighth aspect can include the battery of any one of the first to fifth aspects, wherein the electrode is a cathode disposed in the housing, and wherein the cathode comprises copper or a copper-based compounds.

A ninth aspect can include the battery of the eighth aspect, wherein the cathode comprises the copper-based compound, and wherein the copper-based compound is copper aluminum oxide, copper (I) oxide, copper (II) oxide and/or copper salts in a +1, +2, +3, or +4 oxidation state.

A tenth aspect can include the battery of any one of the first to tenth aspects, wherein the electrode material further comprises a binder, and wherein the binder comprises a polytetrafluoroethylene, a cellulose-based hydrogel, or a combination thereof

An eleventh aspect can include the battery of any one of the first to ninth aspects, wherein the electrode material further comprises a binder, and wherein the binder comprises a cellulose-based hydrogel selected from the group consisting of methyl cellulose (MC), carboxymethyl cellulose (CMC), hydroxypropyl cellulose (HPC), hydroxypropylmethyl cellulose (HPMC), hydroxyehtylmethyl cellulose (HEMC), carboxymethylhydroxyethyl cellulose, or hydroxyethyl cellulose (HEC).

A twelfth aspect can include the battery of any one of the first to ninth aspects, wherein the electrode material further comprises a binder, and wherein the binder is a cellulose-based hydrogel crosslinked with a copolymer selected from the group consisting of polyvinyl alcohol, polyvinylacetate, polyaniline, polyvinylpyrrolidone, polyvinylidene fluoride, polypyrrole, and combinations thereof.

A thirteenth aspect can include the battery of any one of the first to twelfth aspects, wherein the conductive carbon comprises TIMREX Primary Synthetic Graphite, TIMREX Natural Flake Graphite, TIMREX MB, MK, MX, KC, B, LB Grades, TIMREX Dispersions; ENASCO 150G, 210G, 250G, 260G, 350G, 150P, 250P; SUPER P, SUPER P Li, carbon black, acetylene black, carbon nanotubes, graphene, graphyne, graphene oxide, Zenyatta graphite, or combinations thereof.

A fourteenth aspect can include the battery of any one of the first to thirteenth aspects, where in the metallic layer comprises nickel, copper, tin, aluminum, cobalt, silver, nickel-phosphorous, or combinations thereof.

A fifteenth aspect can include the battery of the fourteenth aspect, wherein the metallic layer comprises an oxide or hydroxide-phase of nickel, copper, tin, aluminum, cobalt, or silver.

A sixteenth aspect can include the battery of any one of the first to fifteenth aspects, wherein the electrode is a cathode disposed in the housing, the cathode comprising 1-90 wt. % of the manganese dioxide, 0-30 wt. % bismuth or a bismuth-based compound, 0-50 wt. % copper or a copper-based compound, 1-90 wt. % of the conductive carbon coated with the metallic layer, and 0-10 wt. % binder.

A seventeenth aspect can include the battery of any one of the first to sixteenth aspects, wherein the electrode is a cathode disposed in the housing, and wherein the cathode has a porosity between 5-95%.

An eighteenth aspect can include the battery of any one of the first to seventeenth aspects, wherein the electrode is a cathode disposed in the housing, wherein the battery further comprises a current collector for the cathode or the anode, wherein the current collector is selected from the group consisting of: a copper mesh, a copper foil, a nickel mesh, a nickel foil, a copper plated nickel mesh, or foil, and a nickel-plated copper mesh or foil.

A nineteenth aspect can include the battery of any one of the first to eighteenth aspects, wherein the electrolyte comprises an alkaline hydroxide selected from the group consisting of sodium hydroxide, potassium hydroxide, cesium hydroxide, rubidium hydroxide, lithium hydroxide, or a combination thereof.

A twentieth aspect can include the battery of any one of the first to nineteenth aspects, wherein the electrode is a cathode disposed in the housing, and wherein the battery further comprises a polymeric separator between the anode and the cathode.

In a twenty first aspect, a method of forming a battery comprises: forming a metallic layer on a conductive carbon particle to form a conductive carbon with a metallic layer; combining the conductive carbon with the metallic layer with manganese dioxide to form an electrode mixture; forming an electrode from the electrode mixture; disposing the electrode in a housing; disposing an anode in the housing; and disposing an electrolyte in the housing to form the battery.

A twenty second aspect can include the method of the twenty first aspect, further comprising: combining bismuth or a bismuth-based compound, and copper or a copper-based compound with the electrode mixture prior to forming the electrode from the electrode mixture.

A twenty third aspect can include the method of the twenty first or twenty second aspect, wherein the anode comprises at least 50 wt. % zinc.

A twenty fourth aspect can include the method of any one of the twenty first to twenty third aspects, wherein the manganese dioxide comprises alpha-manganese dioxide, beta-manganese dioxide, gamma-manganese dioxide, lambda-manganese dioxide, epsilon-manganese dioxide, delta-manganese dioxide (or birnessite), chemically modified manganese dioxide, electrolytic manganese dioxide (EMD), or a combination thereof

A twenty fifth aspect can include the method of any one of the twenty first to twenty fourth aspects, further comprising: combining a binder with the electrode mixture prior to forming the electrode from the electrode mixture, wherein the binder comprises a polytetrafluoroethylene, a cellulose-based hydrogel, or a combination thereof.

A twenty sixth aspect can include the method of any one of the twenty first to twenty fourth aspects, further comprising: combining a binder with the electrode mixture prior to forming the electrode from the electrode mixture, wherein the binder comprises a cellulose-based hydrogel selected from the group consisting of methyl cellulose (MC), carboxymethyl cellulose (CMC), hydroxypropyl cellulose (HPC), hydroxypropylmethyl cellulose (HPMC), hydroxyehtylmethyl cellulose (HEMC), carboxymethylhydroxyethyl cellulose, or hydroxyethyl cellulose (HEC).

A twenty seventh aspect can include the method of any one of the twenty first to twenty fourth aspects, further comprising: combining a binder with the electrode mixture prior to forming the electrode from the electrode mixture, wherein the binder is a cellulose-based hydrogel crosslinked with a copolymer selected from the group consisting of polyvinyl alcohol, polyvinylacetate, polyaniline, polyvinylpyrrolidone, polyvinylidene fluoride, polypyrrole, and combinations thereof.

A twenty eighth aspect can include the method of any one of the twenty first to twenty esventh aspects, wherein the conductive carbon comprises TIMREX Primary Synthetic Graphite, TIMREX Natural Flake Graphite, TIMREX MB, MK, MX, KC, B, LB Grades, TIMREX Dispersions; ENASCO 150G, 210G, 250G, 260G, 350G, 150P, 250P; SUPER P, SUPER P Li, carbon black, acetylene black, carbon nanotubes, graphene, graphyne, graphene oxide, Zenyatta graphite, or combinations thereof.

A twenty ninth aspect can include the method of any one of the twenty first to twenty eighth aspects, where in the metallic layer comprises nickel, copper, tin, aluminum, cobalt, silver, nickel-phosphorous, or combinations thereof.

A thirtieth aspect can include the method of any one of the twenty first to twenty ninth aspects, wherein the metallic layer comprises an oxide or hydroxide-phase of nickel, copper, tin, aluminum, cobalt, or silver.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

1. A battery comprising:
a housing;
an electrolyte disposed in the housing;
an anode disposed in the housing;
an electrode disposed in the housing and comprising an electrode material comprising:
manganese dioxide; and
a conductive carbon coated with a metallic layer.

2. The battery of claim 1, wherein the electrode material further comprises:
bismuth or a bismuth-based compound; and
copper or a copper-based compound.

3. The battery of claim 1, wherein the anode comprises at least 50 wt. % zinc, and wherein the zinc comprises metallic zinc or zinc oxide.

4. The battery of claim 1, wherein the anode comprises zinc, iron, aluminum, lithium or magnesium.

5. The battery of claim 1, wherein the manganese dioxide comprises alpha-manganese dioxide, beta-manganese dioxide, gamma-manganese dioxide, lambda-manganese dioxide, epsilon-manganese dioxide, delta-manganese dioxide (or birnessite), chemically modified manganese dioxide, electrolytic manganese dioxide (EMD), or a combination thereof.

6. The battery of claim 1, wherein the electrode is a cathode disposed in the housing, and wherein the cathode comprises bismuth or a bismuth-based compounds.

7. The battery of claim 6, wherein the cathode comprises bismuth oxide, bismuth chloride, bismuth bromide, bismuth fluoride, bismuth iodide, bismuth sulfate, bismuth nitrate, bismuth trichloride, bismuth citrate, bismuth telluride, bismuth selenide, bismuth subsalicylate, bismuth neodecanoate, bismuth carbonate, bismuth subgallate, bismuth strontium calcium copper oxide, bismuth acetate, bismuth trifluoromethanesulfonate, bismuth nitrate oxide, bismuth gallate hydrate, bismuth phosphate, bismuth cobalt zinc oxide, bismuth sulphite agar, bismuth oxychloride, bismuth aluminate hydrate, bismuth tungsten oxide, bismuth lead strontium calcium copper oxide, bismuth antimonide, bismuth antimony telluride, bismuth oxide yittia stabilized, bismuth-lead alloy, ammonium bismuth citrate, 2-napthol bismuth salt, duchloritri(o-tolyl)bismuth, dichlordiphenyl(p-tolyl)bismuth, or triphenylbismuth

8. The battery of claim 1, wherein the electrode is a cathode disposed in the housing, and wherein the cathode comprises copper or a copper-based compounds.

9. The battery of claim 8, wherein the cathode comprises the copper-based compound, and wherein the copper-based compound is copper aluminum oxide, copper (I) oxide, copper (II) oxide and/or copper salts in a +1, +2, +3, or +4 oxidation state.

10. The battery of claim 1, wherein the electrode material further comprises a binder, and wherein the binder comprises a polytetrafluoroethylene, a cellulose-based hydrogel, or a combination thereof.

11. (canceled)

12. The battery of claim 1, wherein the electrode material further comprises a binder, and wherein the binder is a cellulose-based hydrogel crosslinked with a copolymer selected from the group consisting of polyvinyl alcohol, polyvinylacetate, polyaniline, polyvinylpyrrolidone, polyvinylidene fluoride, polypyrrole, and combinations thereof.

13. The battery of claim 1, wherein the conductive carbon comprises TIMREX Primary Synthetic Graphite, TIMREX Natural Flake Graphite, TIMREX MB, MK, MX, KC, B, LB Grades, TIMREX Dispersions; ENASCO 150G, 210G, 250G, 260G, 350G, 150P, 250P; SUPER P, SUPER P Li, carbon black, acetylene black, carbon nanotubes, graphene, graphyne, graphene oxide, Zenyatta graphite, or combinations thereof.

14. The battery of claim 1, where in the metallic layer comprises nickel, copper, tin, aluminum, cobalt, silver, nickel-phosphorous, or combinations thereof.

15. The battery of claim 14, wherein the metallic layer comprises an oxide or hydroxide-phase of nickel, copper, tin, aluminum, cobalt, or silver.

16. The battery of claim 1, wherein the electrode is a cathode disposed in the housing, the cathode comprising 1-90 wt. % of the manganese dioxide, 0-30 wt. % bismuth or a bismuth-based compound, 0-50 wt. % copper or a copper-based compound, 1-90 wt. % of the conductive carbon coated with the metallic layer, and 0-10 wt. % binder.

17. (canceled)

18. The battery of claim 1, wherein the electrode is a cathode disposed in the housing, wherein the battery further comprises a current collector for the cathode or the anode, wherein the current collector is selected from the group consisting of: a copper mesh, a copper foil, a nickel mesh, a nickel foil, a copper plated nickel mesh, or foil, and a nickel-plated copper mesh or foil.

19. The battery of claim 1, wherein the electrolyte comprises an alkaline hydroxide selected from the group consisting of sodium hydroxide, potassium hydroxide, cesium hydroxide, rubidium hydroxide, lithium hydroxide, or a combination thereof

20. (canceled)

21. A method of forming a battery, the method comprising:
forming a metallic layer on a conductive carbon particle to form a conductive carbon with a metallic layer;
combining the conductive carbon with the metallic layer with manganese dioxide to form an electrode mixture;
forming an electrode from the electrode mixture;
disposing the electrode in a housing;
disposing an anode in the housing; and
disposing an electrolyte in the housing to form the battery.

22. The method of claim 21, further comprising:
combining bismuth or a bismuth-based compound, and copper or a copper-based compound with the electrode mixture prior to forming the electrode from the electrode mixture.

23. (canceled)

24. The method of claim 21, wherein the manganese dioxide comprises alpha-manganese dioxide, beta-manganese dioxide, gamma-manganese dioxide, lambda-manganese dioxide, epsilon-manganese dioxide, delta-manganese dioxide (or birnessite), chemically modified manganese dioxide, electrolytic manganese dioxide (EMD), or a combination thereof.

25. The method of claim 21, further comprising:
combining a binder with the electrode mixture prior to forming the electrode from the electrode mixture, wherein the binder comprises a polytetrafluoroethylene, a cellulose-based hydrogel, or a combination thereof.

26.-27. (canceled)

28. The method of claim 21, wherein the conductive carbon comprises TIMREX Primary Synthetic Graphite, TIMREX Natural Flake Graphite, TIMREX MB, MK, MX, KC, B, LB Grades, TIMREX Dispersions; ENASCO 150G, 210G, 250G, 260G, 350G, 150P, 250P; SUPER P, SUPER P Li, carbon black, acetylene black, carbon nanotubes, graphene, graphyne, graphene oxide, Zenyatta graphite, or combinations thereof.

29. The method of claim 21, where in the metallic layer comprises nickel, copper, tin, aluminum, cobalt, silver, nickel-phosphorous, or combinations thereof.

30. The method of claim 21, wherein the metallic layer comprises an oxide or hydroxide-phase of nickel, copper, tin, aluminum, cobalt, or silver.
